(19) United States
(12) Patent Application Publication
(10) Pub. No.: US 2025/0249489 A1
(43) Pub. Date: Aug. 7, 2025

(54) AIR CURTAIN GENERATING DEVICE AND A METHOD FOR ENTERING A TANK

(71) Applicant: Thore HELLAND, Manger (NO)

(72) Inventor: Thore HELLAND, Manger (NO)

(21) Appl. No.: 18/727,813

(22) PCT Filed: Jan. 10, 2023
(86) PCT No.: PCT/NO2023/050004

§ 371 Date: Jul. 10, 2024

(30) Foreign Application Priority Data
Jan. 10, 2022 (NO) 20220032

(51) Int. Cl. B08B 5/02; B65D 90/00; B65D 90/10

(52) U.S. Cl. CPC B08B 5/023; B65D 90/004; B65D 90/10

(57) ABSTRACT

The invention relates to a air curtain generating device (10) for reducing the flow of particles and gas exiting from a manhole (2) on a tank (1). The device (10) is arranged to be attached adjacent to a rim (2.1) of the manhole (2), and has a central aperture (11) with a size and shape configured to let a person pass through said aperture (11) when entering and exiting said tank (1). The device (10) further comprises:—a ring-shaped air nozzle manifold channel (12) surrounding said aperture (11) the air nozzle manifold channel (12) is arranged with a set of nozzles (13) arranged along the periphery of the aperture (11), said set of nozzles (13) is further arranged so that air flowing out through the nozzles (13) is directed towards a focus (F) inside (1.1) the tank (1), generating a continuous air curtain (100) tapering towards the focus (F), and—an air connection on the air nozzle manifold channel (12) to connect the air nozzle manifold channel (12) to a source of pressurized air. The invention also relates to a method for entering and exiting a tank (1) having a manhole (2), while shielding the area outside (1.2) the manhole (2) from the atmosphere inside (1.1) the tank 1

[symbol]

### FIELD OF THE INVENTION

The invention relates to an air curtain generating device for reducing the flow of particles and gas exiting from a manhole on a tank. The invention also relates to a method for entering a tank.

### BACKGROUND OF THE INVENTION

In industrial plants around the world it is a common task to enter tanks of various types for maintenance or inspections. This is for instance a quite common task in many types of process plants such as petrochemical plants and oil refineries.

After a tank has been used for a period of time, the tank will often get dirty on the inside, scale can build up on the inside or they can corrode on the inside. This calls for maintenance and inspections. In many cases it is a need for personnel to enter the tank to perform such tasks. Most tanks over a certain size is therefore equipped with a manhole. A manhole is basically a closable opening of a size that makes it possible for a person to pass through the opening and into the tank.

Entering tanks is potentially dangerous. This can be due to lack of oxygen, remains of chemicals or other factors relating to the atmosphere inside the tank. Due to the danger of entering a tank it is common to have personnel outside the tank monitoring, assisting and supervising the personnel that enter the tank while they are inside the tank.

Maintenance performed inside a tank is typically painting, welding, scraping, sandblasting or washing with high pressure washer. Such activities swirls up dust, particles and frees gasses and fumes to the atmosphere inside the tank. The personnel inside the tank will therefore often wear filter masks, gasmask or other types of Personnel Protecting Equipment (PPE) to be protected from the potentially harmful atmosphere in the tank. However, it is not so not so common that the personnel on the outside is wearing the same PPE as those on the inside.

Particles, gas, fumes and vapors will also escape the tank through the manhole and contaminate an area on the outside of the tank around the manhole. This will in particular affect personnel in close vicinity of the manhole.

When the personnel in the tank is leaving the tank, they will commonly be assisted by personnel on the outside as they crawl out through the manhole. As the personnel on the outside assists the personnel crawling out, they get exposed to fumes, dust etc. that is covering the personnel that is leaving the tank. Personnel that have been doing maintenance inside the tank is often so dirty and covered with dust and/or sand from sandblasting that they completely covers the ground with dust and sand when they are taking of equipment and coveralls outside.

It is a need for a solutions that can reduce the exposure to fumes, gasses and particles released from inside a tank to the area outside the tank. An object of the invention is to provide such a solution.

JP2001072182A relates to a solution for preventing diffusion of dust to the outside during internal inspection work.

EP3248909A1 describes a refuse collection vehicle having a collection container and at least one emptying device, the collection container having a pouring opening and a suction device. The collection container also includes a blowing device which generates an air curtain in the area of the pouring opening by means of nozzle devices.

### SUMMARY OF THE INVENTION

The invention relates to an air curtain generating device for reducing the flow of particles and gas exiting from a manhole on a tank. The device is arranged to be attached adjacent to a rim of the manhole. The device has a central aperture with a size and shape configured to let a person pass through said aperture when entering and exiting said tank (through said manhole). The device further comprises:
a ring-shaped air nozzle manifold channel surrounding said aperture the air nozzle manifold channel is arranged with a set of nozzles arranged along the periphery of the aperture, said set of nozzles is further arranged so that air flowing out through the nozzles is directed towards a focus inside the tank (when the device is attached to the tank), generating a continuous air curtain tapering towards the focus, and
an air connection on the air nozzle manifold channel to connect the air nozzle manifold channel to a source of pressurized air.

The device is arranged to be attached to the tank so that air cannot escape the tank in between the rim of the manhole and the device.

The words “air” and “air curtain” is used while describing the invention and embodiments of the invention. Air is used since it is the most convenient substance to use for generating the curtain, but other compositions of gas that normally would not be referred to as air could also work with the invention. The same goes for air when used to referred to the substance making up the atmosphere inside the tank. The atmosphere inside the tank can comprise substances not normally in air or referred to as air, but it is for convenience referred to as air.

The set of nozzles can be slits. It can be several slits arranged along the periphery of the aperture or it can be one long continuous slit arranged in a stiff channel. The openings is angled so that the stream of air from each nozzle meets in the focus. The focus can be an imagined point (a focusing point) where the air from all the nozzles or the one or more slits meets.

The effect of the invention, when in use, is that the steam of air (the air curtain) will reduce the amount particles, gasses and fumes that exits the manhole through the aperture.

In some cases, there is a second opening (often a smaller opening. i.e. not a manhole) in the tank that can be opened. If this second opening is opened the stream of air from the air curtain device will create a throughput of air for ventilation. The second opening can exit in an area without personnel and/or the exiting air can be routed through a filter for filtering the air exiting the second opening. A hose or some sort of channel can also be connected to this second opening to lead the exiting air out of harm's way.

Even without a second opening in the tank, the air curtain device will reduce the amount of fumes, particles and gases exiting the manhole. The effect both for reducing the number of particles and fumes exiting the tank and the ventilation effect will be better with a second opening.

Another related effect is that personnel crawling out of the tank through the manhole will as they pass through the air curtain be blown clean/flushed by the steam of air. Dust and dirt on the clothes and equipment will be released and will follow the stream of air back into the tank. This will reduce the amount of dust released into the air outside the manhole and reduce the exposure of dust to personnel on the outside of the tank.

The device can further comprise a return air duct, said duct can be arranged to let air pass out of the tank through the manhole outside the air nozzle manifold channel.

In some cases, there will not be a second opening in the tank, or it is not convenient to open a second opening. In such cases a return air duct can be included in the device to allow for circulation/throughput of air. Including a return air duct will anyway be timesaving since there is no need to open a second opening in the tank.

The return air duct can be prolonged on the inside of the tank and/or on the outside. If it is prolonged on the inside of the tank the entrance of the return air duct can for instance be placed in the other end of the tank compare to the manhole. This will improve the circulation of air in the tank. On the outside the exit of the return air duct can be led away from personnel and out of harm's way.

The device can further comprise a filter arranged so that air exiting from the tank through the return air duct is routed through the filter.

Having the return duct makes it much more convenient to filter the air exiting the tank. This is because secondary openings on the tank can have various sizes and shapes and it can therefor be hard to find suitable filters that can be used with each individual tank. The return air duct can have a standard size and be arranged for connection to a filter or for placing a filter in the return duct. Also, secondary openings on tanks might be hard to access for mounting a filter.

The effect of having a filter is that the air exiting the tank can be filtered to remove unwanted substances such as dust, sand and fumes before the air is let into the atmosphere surrounding the tank.

The device can further comprise bolt holes arranged so that the device can be bolted to a corresponding flange on the tank surrounding the manhole.

Preferably the bolt holes is arranged on a flange portion in connection to said air channel, so that the device can be bolted to a corresponding flange on the tank surrounding the manhole.

It is common that manhole has a flange so that a cover can be bolted to the flange for closing the manhole. Including bolt holes in the device will ease the installation of the device to the tank. It will also be easy to include a seal between the device and the flange.

The device can further comprise throughput connections for supplies selected from a list consisting of: signal cables, breading air, sandblasting, paint, electrical power, pressurized air and water, said throughput connections is arranged outside the air nozzle manifold channel.

Personnel entering the tank will in many cases be doing washing and need water from a hose or need a supply to a lance of a high-pressure washer. Other maintenance activities might require pressurized air for sandblasting equipment or similar. The throughput connections on the device is for the personnel inside the tank to be able to connect equipment they need to use directly to a standardized coupling on the inside of the device. It can be supplied throughput connections with standardized coupling on both the inside and on the outside for one or more supplies; water, pressurized water, pressurized air and electrical power.

If such throughput connection is not present hoses for water, and air will have to be passed through the aperture, and will block some of the nozzles so that the effect of the air curtain is reduced. So, the effect of such means for providing connections for pressurized air, pressurized water and power is an increase of the efficiency of the device in cases where hoses or cables is needed.

The device can further comprises a through channel, in the device. The through channel is stretching between a side arranged to face inside the tank, and a side arranged to face outside the tank. Said through channel is arranged outside the nozzle manifold channel and comprises an elastic sealing cuff.

Such a through channel is suitable for passing through cables, tubes and hoses. This through channel can be in addition to or instead of throughput connections for supplies. When a worker inside the tank for instance needs a water hose for cleansing inside the tank, he can pass the hose through the through channel and pull it in as far as he needs while the elastic sealing cuff seals around the hose preventing contaminated air from escaping out from the tank.

The invention also relates to a method for entering and exiting a tank having a manhole, while shielding the area outside the manhole from the atmosphere inside the tank. The method comprises the steps of:
removing the cover on the manhole,
installing the air curtain generating device, as described above, on the tank adjacent to the rim of the manhole,
turn on a flow of pressurized air to generate an air curtain,
entering the tank by crawling in through the aperture,
performing inspections and/or maintenance inside the tank, and
exiting the tank by crawling out through the aperture, while being flushed clean by the air curtain.

Turning on the flow of pressurized air can also be done after personnel have entered the tank instead of before entering the tank through the aperture. What is important is that the pressurized air is turned on before activities that frees dust, gas etc. commences.

### DESCRIPTION OF THE DIAGRAMS

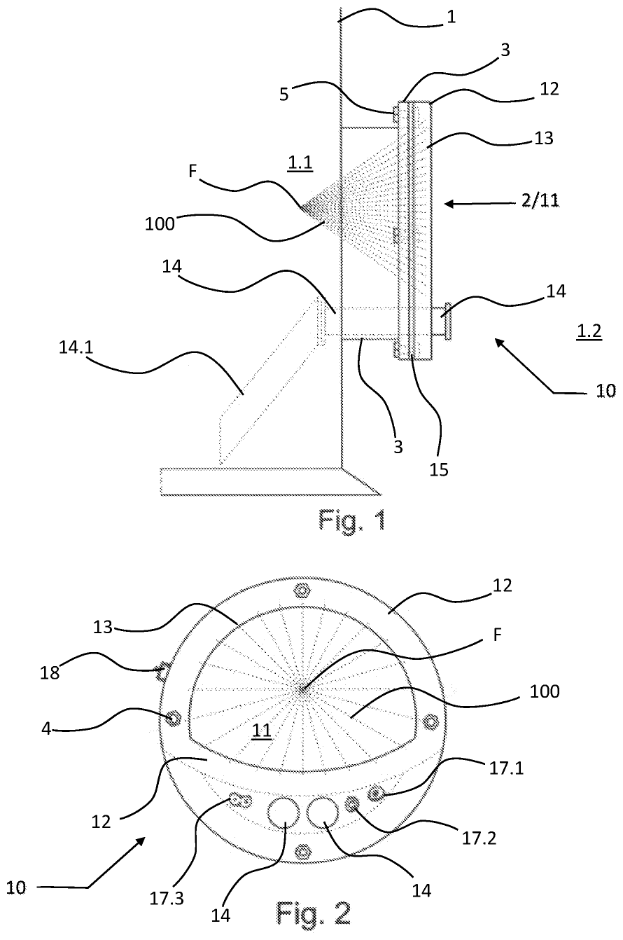

FIG. 1 shows an embodiment of the inventive device from the side. The device is mounted on a flange on a manhole on a tank. The airstreams of the air curtain and parts of the device that is inside the tank is drawn with dotted lines.

FIG. 2 shows the embodiment from FIG. 1 from the front as it will be seen when mounted on the tank and one is looking into a manhole on the tank through the aperture of the device.

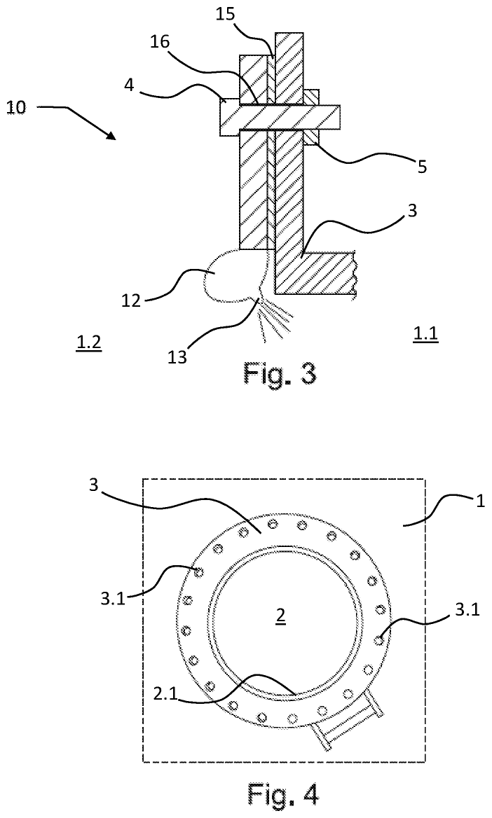

FIG. 3 shows a section of an embodiment of the invention bolted to a flange on a manhole showing one possible way of connecting the device to a tank.

FIG. 4 shows a typical manhole on a tank with a hinge connection for a cover and a flange with holes for bolts for bolting on a cover. The holes can also be used for bolting an air curtain generating device to the tank.

Reference numbers

| | |
|---|---|
| 1 | Tank |
| 1.1 | Inside tank |
| 1.2 | Outside the tank |
| 2 | Manhole |
| 2.1 | Rim of manhole |
| 3 | Flange |
| 3.1 | Flange bolt holes |
| 4 | Bolt |
| 5 | Nut |
| 10 | Air curtain generating device (or device as short version) |
| 11 | Aperture |
| 12 | Air nozzle manifold channel |
| 13 | Nozzle |
| 14 | Return air duct |
| 14.1 | Extension of return air duct |
| 15 | Seal |
| 16 | Bolt holes |
| 17 | Throughput connections (17.1, 17.2, 17.3 etc.) |
| 17.1 | Throughput connection for pressurized air |
| 17.2 | Throughput connection for water |
| 17.3 | Throughput connection for electrical power |
| 18 | Air connection |
| 100 | Air curtain |
| F | Focus (focus of nozzles, i.e. where the air exiting the nozzles |
| | is directed towards) |

### DESCRIPTION OF PREFERRED EMBODIMENTS OF THE INVENTION

In the following embodiments of the invention will be described with reference to the figures (FIG. 1-4).

FIG. 1 shows the device 10 mounted on a flange 3 on a tank 1. The device 10 is in this embodiment bolted to the flange 3 using bolts 4 and nuts 5. In this embodiment the device 10 is equipped with two return air ducts 14 (only one is visible in FIG. 1). The device 10 is oriented so that the return air ducts 14 is at the lower part of the manhole 2. The device 10 can be arranged with only one return air duct 14 or with more than two. The device 10 can also have another orientation relative to the manhole 2 so that the return air duct 14 for instance are in the upper part of the manhole 2. Further, the return air ducts 14 is extended into the tank with an extension 14.1 of the return air duct (displayed with dotted lines).

In FIG. 1 the air streams of the air curtain 100 is displays with dotted lines and it is clearly visible how the airstreams is tapering towards a focus F where they meet.

FIG. 2 shows the device 10 from front as one will see the device 10 looking into the tank 1 through the manhole 2 when the device 10 is mounted on the tank 1. The tank is not showed in FIG. 2, only the device 10. The airstreams from each of the nozzles 13 making up the air curtain 100 is seen as dotted lines inside the aperture 11. The airstreams from the nozzles 13 meets in the focus F.

Two return air ducts 14 is also seen in FIG. 2 and next to the return air ducts 14 throughput connections 17 for pressurized air 17.1, water 17.2 and electrical power 17.3 is seen. These throughput connection 17 is configured so that a standard connection on a water hose, an air hose and an electrical cable such as an extension cable can be plugged into the throughput connection 17 on the outside 1.2 of tank 1. On the inside 1.1 of the tank 1 personnel can connect their pressure washer lances, sandblasting equipment, lamps etc. to standard connections. This makes it much easier to work inside the tank 1 and there is no need to pass hoses and cables through the air curtain 100 and thereby reduce the effect of the air curtain 100 by blocking for the stream of air from some of the nozzles 13.

The air connection 18 is also visible in FIG. 2. A hose from a compressor or similar can be connected to the air connection 18 to supply the air nozzle manifold channel 12 with pressurized air for generating the air curtain 100.

FIG. 3 shows part of an embodiment of the device 10 in section and part of the flange 3 on the tank 1 in section. A seal 15 is arranged between the device 10 and the flange 3 to ensure that no air passes in or out of the tank 2 between the device 10 and the flange 3. As seen the device 10 is bolted to the flange 3 using bolts 4 and nuts 5. In this section only one bolt 4 and nut 5 is visible. The air nozzle manifold channel 12 is seen in section with one nozzle 13 visible in this section. The nozzle 13 directs air with an angle into the tank 1 through the manhole 2.

FIG. 4 shows a typical manhole 2 with a surrounding flange 3. The flange 3 is equipped with holes for bolts 3.1 so that a cover can be bolted to the flange 3 to seal of the tank 1. In FIG. 4 the cover (not seen in the figures) is removed to open the tank 1 and so that the device 10 can be mounted on the tank 1.

In cases where the tank is equipped with a flange 3 surrounding the manhole 2, the device 10 can be bolted to a flange 3 as displayed in FIG. 4.

With the device 10 bolted to the flange 3 a hose for pressurized air can be connected to the air connection 18 on the air nozzle manifold channel 12. If needed electrical power, water and pressurized air can be connected to the throughput connections 17.

When pressurized air is connected and turned on, the device 10 is generating an air curtain 100 and personnel can now enter the tank 1 through the aperture 11 and the outside of the tank 1 is sheltered from the atmosphere inside the tank 1.

After crawling in through the aperture 11 and the manhole 2 personnel can performe maintenance. Sandblasting and other activities can be done without spreading sand uncontrolled out through the manhole 2. Personnel outside the tank, that is set to watch and supervise personnel on the inside of the tank, can look in through the manhole 2 without being exposed to a potential harmful atmosphere on the inside of the tank 1. The device 10 will ventilate the tank providing fresh air and visibility as whirled up particles and dust will be ventilated out through the return air duct where it can be filtered and/or lead out of harms way.

When personnel inside the tank 1 have finished, they can crawl out through the manhole 2 and the aperture 11 while being flushed clean by the air flowing from the nozzles 13 on the way out. Dust and dirt will be blown back into the tank 1 and part of it will be ventilated out through the return air duct 14. Personnel on the outside can help without being exposed to dust from equipment and personnel that have been inside the tank 1.

1. Air curtain generating device (10) for reducing the flow of particles and gas exiting from a manhole (2) on a tank (1), wherein the device (10) is arranged to be attached adjacent to a rim (2.1) of the manhole (2), the device (10) has a central aperture (11) with a size and shape configured to let a person pass through said aperture (11) when entering and exiting said tank (1), wherein the device (10) further comprises:
a ring-shaped air nozzle manifold channel (12) surrounding said aperture (11) the air nozzle manifold channel (12) is arranged with a set of nozzles (13) arranged along the periphery of the aperture (11), said set of nozzles (13) is further arranged so that air flowing out through the nozzles (13) is directed towards a focus (F) inside (1.1) the tank (1), generating a continuous air curtain (100) tapering towards the focus (F), and
an air connection on the air nozzle manifold channel (12) to connect the air nozzle manifold channel (12) to a source of pressurized air, and
a return air duct (14), said return air duct (14) being arranged to let air pass out of the tank (1) through the manhole (2) outside the air nozzle manifold channel (12).

2. (canceled)

3. Air curtain generating device (10) according to claim 1, wherein the device (10) further comprises a filter arranged so that air exiting from the tank (1) through the return air duct (14) is routed through the filter.

4. Air curtain generating device (10) according to claim 1, wherein the device (10) further comprises bolt holes (16) arranged so that the device (10) can be bolted to a corresponding flange (3) on the tank (1) surrounding the manhole (2).

5. Air curtain generating device (10) according to claim 1, wherein the device (10) further comprises throughput connections (17) for supplies selected from a list consisting of: signal cables, breading air, sandblasting, paint, electrical power (17.3), pressurized air (17.1) and water (17.2), said throughput connections (17) is arranged outside the air nozzle manifold channel (12).

6. Air curtain generating device (10) according to claim 1, wherein the device (10) further comprises a through channel, in the device (10) stretching between a side arranged to face inside the tank (1.1), and a side arranged to face outside the tank (1.2), wherein said through channel is arranged outside the nozzle manifold channel (12) and comprises an elastic sealing cuff.

7. A method for entering and exiting a tank (1) having a manhole (2), while shielding the area outside (1.2) the manhole (2) from the atmosphere inside (1.1) the tank 1, wherein the method comprises the steps of:
removing the cover on the manhole (2),
installing the air curtain generating device (10), according to claim 1 on the tank (1) adjacent to the rim (2.1) of the manhole (2),
turn on a flow of pressurized air to generate an air curtain (100),
entering the tank (1) by crawling in through the aperture (11),
performing inspections and/or maintenance inside the tank (1), and
exiting the tank (1) by crawling out through the aperture (11), while being flushed clean by the air curtain (100).
